(19) United States
(12) Patent Application Publication
(10) Pub. No.: US 2013/0344358 A1
(43) Pub. Date: Dec. 26, 2013

(54) BATTERY COMPARTMENT FOR A VEHICLE

(71) Applicants: Lionel Colibert, Montaure (FR); Sylvain Delvallee, Franqueville Saint Pierre (FR); Jerome Estienne, Issy Les Moulineaux (FR)

(72) Inventors: Lionel Colibert, Montaure (FR); Sylvain Delvallee, Franqueville Saint Pierre (FR); Jerome Estienne, Issy Les Moulineaux (FR)

(73) Assignee: RENAULT S.A.S., Boulogne-Billancourt (FR)

(21) Appl. No.: 13/878,377

(22) PCT Filed: Oct. 5, 2011
(86) PCT No.: PCT/FR2011/052321

§ 371 Date: Sep. 12, 2013

(30) Foreign Application Priority Data
Oct. 7, 2010 (FR) 1058136

(51) Int. Cl. H01M 10/50

(52) U.S. Cl. CPC H01M 10/5016
USPC 429/83

(57) ABSTRACT

A battery compartment for an electric vehicle, including: an inlet for a cooling fluid on a first wall, and at least one outlet for the fluid on a second wall. The compartment includes stacks of battery modules arranged in at least one row along a main flow channel for the fluid, each module stack along the main channel being separated from a next module by a secondary channel. The width of the secondary channel can be varied along the length of the main channel, so as to produce a substantially constant fluid flow in each of the secondary channels.

The invention relates to the power supply of a vehicle provided with an electrical drive system and more particularly a battery compartment functioning as the electrical energy supply for this system.

The vehicles provided with an electrical drive system draw their electrical energy from batteries. During release and storage of this electrical energy, outside or in the batteries, an exothermic chemical process takes place, raising the temperature of the battery modules. Now the operation of the latter is very sensitive to the temperature, which must then be maintained around a target temperature in a specified operating range. In this way a reduction of performances of the battery is avoided, for example a loss of capacity, if the temperature is too low, or a degradation of the useful life, if the temperature is too high.

A need therefore exists to maintain the battery modules at a temperature as close as possible to the target temperature. In addition, the battery compartments may be provided with a large number of modules or a different number of modules from one stack to another. Consequently, a need also exists to reduce the temperature gradient between the modules as much as possible, to prevent one or more modules from being subjected to operating conditions more severe than those of the other modules, which would reduce the performances and/or the useful life thereof.

Patent document FR 2876223 proposes a battery compartment wherein an air stream enters through an inlet of the compartment and circulates toward an outlet in order to cool the battery modules by forced convection. The modules to be cooled are arranged so as to form at least one channel between the rows of stacks of modules, extending from the inlet to the outlet of the compartment, wherein the width of this channel becomes smaller along the flow direction, thus forming a V. The air therefore circulates along this channel and between the modules by virtue of the presence of deflectors that divert part of the flow circulating in this channel. The progressive reduction of the width of this channel makes it possible to accelerate the fluid stream in proportion to its advance into the compartment and thus to increase the heat exchange capacity between the modules situated toward the outlet and the air stream that is heated by the modules situated close to the fluid inlet. However, such a system does not permit satisfactory homogenization of the cooling of the modules in the compartment.

One goal of the present invention is to propose an improved battery compartment, which in particular obviates all or part of the aforesaid drawbacks in order to cool all the modules of a battery compartment uniformly around a target temperature, within a specified range of operating temperature.

To this end, the invention proposes a battery compartment for an electric motorized vehicle provided on a first wall with an inlet for a cooling fluid and on a second wall with at least one outlet for this fluid, the said compartment containing stacks of battery modules arranged in at least one row along the main flow channel of the admitted fluid, each stack of modules along the main channel being separated from the next by a secondary channel of variable width, so as to obtain a substantially constant fluid flow rate in each of the secondary channels.

Such a compartment permits fluid circulation in a substantially constant stream between each stack of modules, with the effect of cooling them homogeneously, resulting in an improvement of the performances and a prolongation of the useful life of the battery.

According to other advantageous characteristics of the invention:
the width of the i-th secondary channels can vary as a function of the distance Di
that separates the intersection between the i-th secondary channel and the main channel from the fluid inlet, thus making it possible to obtain a homogeneous distribution of the fluid between the secondary channels and to achieve homogeneous cooling, particularly for compartments of great length;
the width of the i-th secondary channels may be equal to a predetermined coefficient a multiplied by the distance Di, to which there is added a width L0 representing the zeroth secondary channel situated between the compartment wall in which the fluid inlet is formed and the first stack.
the width of the i-th secondary channels can vary as a function of the number of modules present in the stacks situated around this channel, thus making it possible to obtain a homogeneous distribution of the fluid between the secondary channels and to achieve homogeneous cooling, particularly for compartments in which the number of modules in the stacks varies, as consequently does the quantity of heat to be extracted;
the width of the i-th secondary channels may be equal to a predetermined coefficient b multiplied by the number Ni of modules in the stacks bordering this i-th secondary channel 30i, to which there is added a width L0 of the zeroth secondary channel situated between the compartment wall in which the fluid inlet is formed and the first stack.
the width of the secondary channels can become smaller along a transversal axis T between a first end situated at the intersection between the i-th secondary channel and the main channel up to a second end, so as to induce acceleration of the fluid circulating therein, thus making it possible to assure homogeneous cooling of the walls of the modules facing this channel, particularly in the case that the secondary channels have great length.
the compartment may be provided with a single row of stacks, the main channel being situated between the row of stacks and one of the side walls of the compartment joining the first and the second wall, thus making it possible to design very compact compartments with great cooling homogeneity.
the compartment may be provided with at least two rows of stacks and at least one main channel situated between these two rows.
the main channel may extend substantially along the longitudinal axis passing through the inlet, thus making it possible to achieve a symmetric stream of cooling fluid circulating between the stacks of modules.
the width of a main channel may become smaller over its length extending between the fluid inlet and the outlet, so as to induce acceleration of the fluid circulating therein, thus making it possible to assure homogeneous cooling of the walls of the modules facing this channel, particularly in the case that the main channel has great length.
at least one outlet may be situated on a longitudinal axis separate from the longitudinal axis L passing through the fluid inlet 7, thus making it possible to favor circulation of the cooling fluid in a transversal direction T and to increase the tendency of the cooling fluid to pass through the secondary channels, in this way increasing the efficiency and homogeneity of cooling.

This invention also relates to an electric vehicle equipped with this compartment and to the use of this compartment for an electric vehicle.

The invention will be understood better by reading the detailed description of one embodiment, construed as non-limitative and illustrated by the attached drawings, wherein:

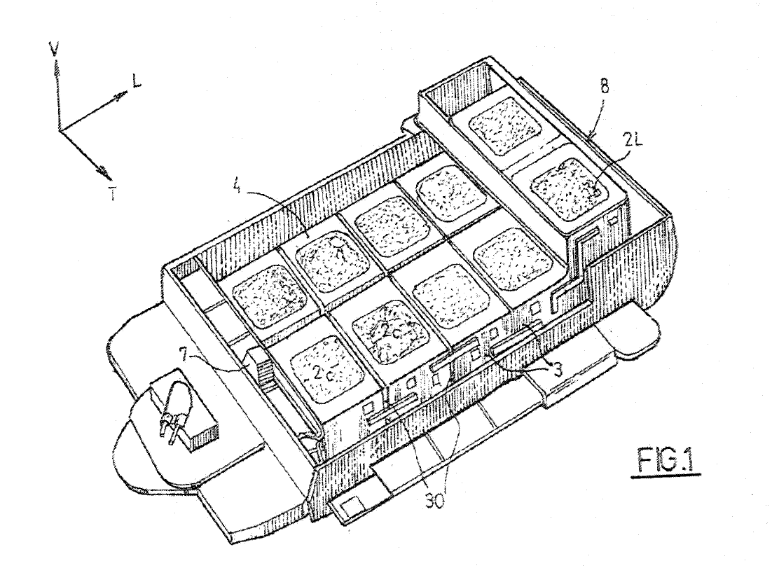

FIG. 1 is a perspective view from above of a stack of batteries according to the invention,

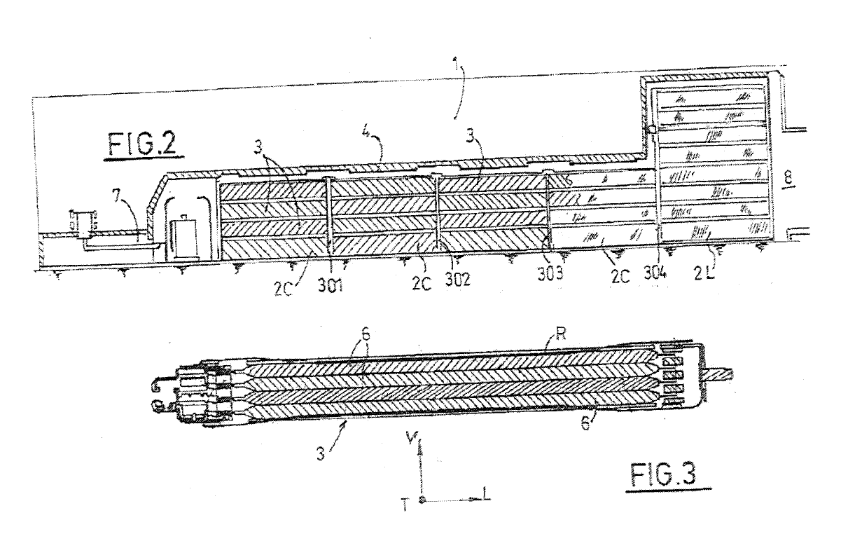

FIG. 2 is a view in section in the plane [L-V] of this same compartment,

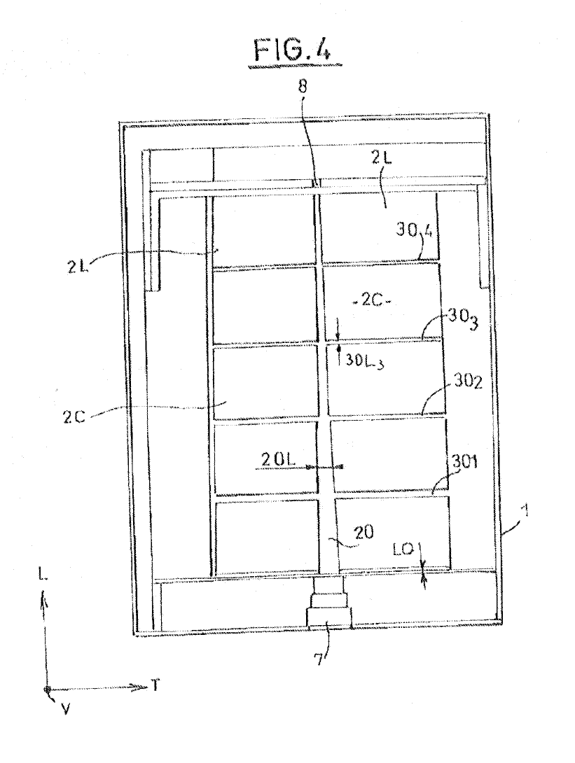

FIG. 3 is a view in section in the plane [L-V] of a module composed of 4 elementary cells,

FIG. 4 is a view from above of an open compartment detailing the arrangement and the distribution of the stacks of modules in the compartment.

In the description to follow, a longitudinal, vertical and transversal orientation according to the direct three-coordinate system L, V, T represented in the figures will be adopted, construed as non-limitative.

In FIG. 1, a battery compartment 1 intended to power a vehicle provided with an electrical drive system, such as an electric vehicle or a hybrid vehicle (not represented) is illustrated in a perspective view from above. This compartment 1 is provided with two rows of stacks extending along a longitudinal axis L, in the form of short stacks 2C and long stacks 2L, forming a main channel 20 for flow of a cooling fluid, such as air.

The flow direction of the stream of fluid in this main channel 20 will be adopted as the orientation of this longitudinal axis L. Main channel 20 joins a fluid inlet 7 to a fluid outlet 8, formed in the casing of compartment 1. Fluid inlet 7 is adapted to be connected to a ventilation device, for example a ventilation and air-conditioning device of a motor vehicle (“HVAC” in English), in order to receive a stream of cooling fluid. Fluid outlet 8 can be connected to a fluid-extraction device in order to exhaust the stream of fluid from the compartment.

Each stack 2C, 2L is composed of a superposition of modules 3 extending along vertical axis V and held one against the other by compression plates 4. Modules 3 forming stacks 2 are electrically connected with one another in order to form a battery.

As illustrated in FIG. 2 detailing a section in plane [L-V] of compartment 1, compartment 1 is provided with two types of stacks, short stacks 2C provided with 3 superposed modules and long stacks 2L provided with eight superposed modules 3. Compartment 1 is provided with ten stacks 2C, 2L: two long stacks 2L, placed on both sides of main channel 20, at the end of the channel situated close to fluid outlet 8, and eight short stacks 2C, placed on both sides along main channel 20, between fluid inlet 7 and long stacks 2L.

Other arrangements of modules in the stacks, especially in number, may of course be envisioned, depending on the space constraints and the performances, such as the required power or electrical voltage.

In FIG. 3, a module 3 composed of elementary cells 6 held and electrically connected with one another in a receptacle R is illustrated along a section in plane [L-V]. Elementary cells 6 are the site of exothermic chemical reactions, which produce heat that must be removed outside the battery during charge and discharge cycles. In order to obtain a high energy density, these cells 6 are placed one against another, the heat being transferred from one cell 6 to the other step-by-step until it reaches the wall of receptacle R. In this way the walls of receptacle R receive the heat emitted by elementary cells 6, this heat then being removed mainly by convection. The heat is removed, for example, by circulation of a cooling fluid such as air along the wall.

The number of elementary cells 6 may vary as a function of the characteristics of the desired battery, and may be equal to four, as represented in FIG. 3.

FIG. 4, in a view from above of open compartment 1, details a particular arrangement of stacks 2C, 2L of modules 3 according to the invention, permitting improved cooling of modules 3.

The cooling fluid flows from fluid inlet 7 toward fluid outlet 8, formed in the casing of compartment 1, through main channel 20, thus cooling the walls of modules 3 exposed to main channel 20. Since the fluid travels a relatively long path in compartment 1 before it reaches outlet 8, it may lose its heat-removal power for stacks 2C, 2L of modules 3 situated close to this outlet 8. For this reason, width 20L of main channel 20 varies along this path, so as to accelerate the velocity of the fluid stream from downstream to upstream. Consequently, width 20L decreases as outlet 8 is approached. In this way, main channel 20 forms a V in plane [L-T] when it is viewed from above.

So-called “secondary” channels 30, extending in a transversal direction T, are formed between stacks 2C, 2L of modules 3. The fluid can then circulate over at least one other of the walls of modules 3 that has a larger surface than the walls exposed in main channel 20.

During its travel along main channel 20, a portion of the fluid is directed into secondary channels 30.

According to the invention, width 30L of secondary channels 30 is variable along main channel 20.

According to a first embodiment, width 30L of secondary channels 30 is larger toward fluid outlet 8 of compartment 1. In this way, width 30Li of the i-th secondary channel 30i is a function of the distance Di separating the intersection between this i-th secondary channel 30i and main channel 20 from fluid inlet 7 of compartment 1. In this way, in proportion to the increase in this distance Di, width 30Li of the i-th secondary channel 30 increases.

Width 30Li of these secondary channels 30 is such that it is equal to a coefficient a multiplied by the distance Di, to which there is added a width L0 of the zeroth secondary channel situated between the wall of the compartment in which fluid inlet 7 is formed and first stack 2C, 2L.

Constants a and L0 are predetermined during the design phase, for example by adapting these constants so that the stream measurements in each of the secondary channels are substantially equal.

According to a second embodiment, particularly adapted to battery compartments 1 in which the dimensions of the stacks vary, width 30L of the secondary channels varies as a function of the number of modules 3 of stacks 2C, 2L. More precisely, in the embodiment presented in FIGS. 2 and 3, width 30L of secondary channel 30 separating consecutive long stacks 2L and short stacks 2C is even larger than width 30L of secondary channels 30 separating two consecutive short stacks 2C. In this way the stream of cooling fluid is adapted to the quantity of heat produced by stacks 2C, 2L of module 3, which quantity is greater in proportion to the increase in number of modules 3 per stacks 2C, 2L.

If Ni is the number of modules 3 present in the i-th stacks 2C, 2L, width 30Li of these secondary channels 30i is such that it is equal to a coefficient b multiplied by the number Ni of modules 3 in the stacks bordering this i-th secondary channel 30i, to which there is added a width L0 of the zeroth secondary channel situated between the wall of the compartment in which fluid inlet 7 is formed and first stacks 2C, 2L.

Constants b and L0 are predetermined during the design phase, for example by adapting these constants so that the stream measurements in each of the secondary channels are substantially equal.

According to a third embodiment, width 30L of secondary channels 30 varies both in the manner in which it varies in the first embodiment and in the manner in which it varies in the second embodiment.

As an alternative (not represented), width 30L of secondary channels 30 may vary along transversal axis T in a manner analogous to the reduction of width 20L of main channel 20 along longitudinal axis L, so as to accelerate the stream of cooling fluid in secondary channel 30. In this way, secondary channel 30 forms a V in plane [L-V] when it is viewed from above. This decrease of width 30L may be applied linearly between a first end situated at the intersection between secondary channel 30 and main channel 20 as far as its second end. This alternative increases the cooling efficiency when secondary channels 30 are long.

Although the invention has been described in relation to a compartment integrating two rows of stacks 2C, 2L, it is also applicable to a compartment integrating a single row.

Compartment 1 is then provided with a single row of stacks 2C, 2L, main channel 20 then extending along a substantially longitudinal axis L between the said row and a side wall of compartment 1 joining the first and second sides in which fluid inlet 7 and fluid outlet 8 respectively are formed.

Of course, the invention is also applicable to a compartment having at least three rows of stacks 2C, 2L separated by at least two main channels 20. Adapted to compartments of large dimensions, that permits greater fluid circulation capacity.

According to another alternative (not represented), the compartment may be provided with at least one second fluid outlet. Preferably, these outlets are not formed on longitudinal axis L passing through the fluid inlet. In this way, the admitted fluid circulating in the main channel impinges at the end thereof on a wall of the compartment. By placing the two fluid outlets in the vicinity of the downstream ends of the secondary channels, circulation of cooling fluid in a transversal direction T is favored. Consequently, the tendency of the cooling fluid to pass into the secondary channels is increased, thus increasing the efficiency and homogeneity of cooling.

All these configurations make it possible to obtain the most homogeneous possible flow rate of fluid between the rows of stacks of modules.

1-8. (canceled)

9. A battery compartment for an electric motorized vehicle provided on a first wall including an inlet for a cooling fluid and on a second wall including at least one outlet for the fluid, the compartment comprising:
stacks of battery modules arranged in at least one row along a main flow channel of the fluid, each stack of modules along the main channel being separated from a next stack of modules by a secondary channel,
wherein the width of the secondary channel is equal to a ·D+L, wherein a is a coefficient, D is the distance that separates an intersection between the secondary channel and the main channel from the fluid inlet, and L is the width of the secondary channel situated between the wall of the compartment in which the fluid inlet is formed and the first stack, so as to obtain a substantially constant fluid flow rate in each of the secondary channels.

10. A battery compartment for an electric motorized vehicle according to claim 9, wherein the width of the secondary channels decreases along a transversal axis between a first end situated at the intersection between the secondary channel and the main channel as far as a second end, so as to induce acceleration of the fluid circulating therein.

11. A battery compartment for an electric motorized vehicle according to claim 9, including a single row, the main channel being situated between the row of stacks and one of side walls of the compartment joining the first and the second wall.

12. A battery compartment for an electric motorized vehicle according to claim 9, including at least two rows of stacks and at least one main channel situated between the two rows.

13. A battery compartment for an electric motorized vehicle according to claim 9, wherein the main channel extends substantially along the longitudinal axis passing through the inlet.

14. A battery compartment for an electric motorized vehicle according to claim 9, wherein the width of the main channel decreases along its length extending between the fluid inlet and the outlet so as to induce acceleration of the fluid circulating therein.

15. A battery compartment for an electric motorized vehicle according to claim 9, wherein at least one outlet is situated on a longitudinal axis separate from the longitudinal axis passing through the fluid inlet.

16. A motor vehicle with an electrical drive system, comprising a battery compartment according to claim 9.
